(19) United States
(12) Patent Application Publication
(10) Pub. No.: US 2009/0234664 A1
(43) Pub. Date: Sep. 17, 2009

(54) System and method for recommending entertainment venues for specific occasions

(76) Inventors: Wayne A. Schaffnit, (US); Shane M. Smith, (US)

Correspondence Address: Wayne A. Schaffnit, 340 Duncan Street, San Francisco, CA, 94131, US

(21) Appl. No.: 12/075,285

(22) Filed: Mar. 11, 2008

(51) Int. Cl. G06Q 99/00

(52) U.S. Cl. 705/1

(57) ABSTRACT

An Internet based method and system for recommending restaurants for specific occasions that provides users with precise information of the anticipated price of a meal, precise information regarding suitable attire, and specific rating information derived from selected demographic categories.

### CROSS-REFERENCE TO RELATED APPLICATIONS

None.

### FEDERALLY SPONSORED RESEARCH

None.

### SEQUENCE LISTING OR PROGRAM

None.

### BACKGROUND OF THE INVENTION

1. Field of Invention

This invention generally relates to recommendation systems capable of recommending venues for entertaining to a given user, based on recommendations of other users of the system. In particular, the current invention relates to an improved methodology for enhancing the value of possible recommendations within Internet-based restaurant recommendation systems.

2. Prior Art

With the Internet, which provides both access technology and communication infrastructure, groups of individuals with common interests have formed virtual communities, and some of these communities have focused on communicating recommendations for various products and services. An associated area of enabling technology is the “collaborative filtering” or “social filtering” of information on the Internet regarding people's opinions of various products and services.

Collaborative filtering technologies represent techniques for filtering information that do not rely on the “contents” of objects, as is the case for content-based filtering. Instead, filtering relies on meta data “about” objects. This meta data may be either collected automatically, such as data that is inferred from the users' interactions with the system, or it may be voluntarily provided by the users of the system. In either case, in this application the objective is to automate the process by which people recommend products or services to one another, and to organize and store the associated information in such a manner that it can be easily sorted and searched by multiple criteria.

Automation of recommendation systems is significant, because in choosing among a wide variety of options with which one does not have any experience, one will often seek the opinions of others who are knowledgeable in the subject area. However, when there are potentially many thousands of options, most of which may be entirely unknown to the advice-seeker, it becomes practically impossible for an individual to locate reliable experts that can give advice about every one of the options. By shifting from an individual to a collective method of recommendation, the problem becomes more manageable.

The basic mechanism behind existing collaborative filtering systems is the following:
a large group of people's preferences are registered;
using a similarity metric, a subgroup is selected whose preferences are similar to the preferences of the person who seeks advice,
a (possibly weighted) average of the preferences for that subgroup is calculated;
the resulting preference function is used to recommend options on which the advice-seeker has expressed no personal opinion yet.

If the similarity metric has indeed selected a subgroup of people with similar tastes, the chances are great that the options that are highly evaluated by that group will also be appreciated by the advice-seeker.

There are several examples of developments with these technologies, including:

John B. Hey, “System and method of predicting subjective reactions”, U.S. Pat. No. 4,870,579 and “System and method for recommending items”, U.S. Pat. No. 4,996,642;

Christopher P. Bergh, et al, “Distributed system for facilitating exchange of user information and opinion using automated collaborative filtering”, U.S. Pat. No. 6,112,186;

Patrick G. Sobalvarro, et al, “System and Method for Grouping and Selling Products or Services”, U.S. Pat. No 7,092,892;

Shahar (Boris) Smirin, et al, “Method and System for Providing Customized Recommendations to Users”, U.S. Pat. publication 20070143281.

Internet applications of recommendation systems using collaborative filtering technologies include communities of members who exchange recommendation of books, movies, travel destinations, and restaurants. In this invention, the definition of restaurants shall include all types of venues for entertaining on specific occasions, such as restaurants, bars, clubs, and other such establishments.

FIG. 1 is a list of restaurant recommendation systems and their Internet domain addresses. Despite their application of existing collaborative filtering technologies, all have flaws in their similarity metrics which prevent them from providing complete and specific recommendations to certain advice-seekers. These flaws, and others described in the paragraphs below, illustrate the need for continued improvement in the art.

Restaurant recommendation systems may present as many as three different types of information; specific, subjective, and consensus.

Specific information is factual data, such as a restaurant's name, address, telephone number, the type or style of the food, and hours of operation. Users of recommendation systems for restaurants can reliably expect to learn this type of information from many recommendation systems.

Subjective information, however, is information that relies upon interpretation and potentially arbitrary judgment. An example is communicating to users the pricing at a particular dining establishment. A common method for describing the pricing is through the use of a series of monetary symbols in conjunction with a simple code. That is; a single dollar sign, “$”, represents an “inexpensive” meal, two dollar signs, “$$” indicates a “modestly priced” meal, and three or more dollar signs signifies that meals are “expensive”. FIG. 2 contains a table of pricing information for a specific restaurant that is available on restaurant recommendation systems.

The overall problem with this approach is that it is excessively vague. Eight of the recommendation systems; 2C, 2E, 2I, 2K, 2N, 2Q, 2T, and 2V listed in FIG. 2 indicate pricing of “$$$$” for the restaurant specified. In some of the recommendation systems, the “$$$$” rating, however, either has no associated explanation (2I, 2Q), or only a general interpretation (2C). In the other recommendation systems listed, the “$$$$” rating has a numeric figure that can be used to interpret the code, but the pricing information provided ranges from a low of $25 (2D) to a high of more than $85 (2N). Further specificity and precision in this area would be of great value to users.

Another problem with the information provided on restaurant recommendation systems is the lack of a clear definition of a “meal”. Only five of the recommendation systems listed in FIG. 2 (2D, 2I, 2P, 2T, 2W) provide any details about what is included within their pricing guideline. The definition ranges from a low of “Per entree” (2D and 2T) to “3-course menu $68, 4-course $76, 5-course $88” (2J and 2P) to “estimated one dinner, one drink+tip” (2W). An improvement in the precision and specificity of this area would be a great advantage to users.

Another instance of the need for improving subjective information within restaurant recommendation systems is the definition of appropriate attire. Similar to the approaches used for communicating the range of prices described above, existing recommendation systems use only broad generalizations to describe the attire that may be appropriate for a given dining establishment. FIG. 3 is a table which lists suggested attire information available on existing restaurant recommendation systems.

FIG. 3 lists 23 restaurant recommendation systems, 22 of which include information about the particular restaurant cited. Of the 22 recommendation systems, only eight had information about appropriate attire for the particular restaurant cited; 3A, 3C, 3F, 3I, 3J, 3K, 3V, and 3W. Within these eight listings, the definitions of appropriate attire ranged from “Business Casual, Jacket Preferred” 3A, to “Ties Suggested” 3C, to “Jacket Suggested” 3W, to “Jacket Required” 3I, to “Dressy” 3F, 3J, 3K, and 3V. These terms are inconsistent at best and contradictory at worst. More precision and specificity in this area would be of great benefit to users of the system.

The third type of information recommendation systems feature is consensus information, which is frequently used to describe the overall ranking, rating, status, or appeal of a given dining establishment. The most common method used to address this issue is by using a rating system consisting of one, two, three, four, or five “star” symbols. A single star indicates a low ranking, while a “five star rating” is assigned to only the most elite restaurants. The problem with this approach is that it indicates only an overall rating for a given establishment and does not consider what type or types of events the establishment is most suitable for hosting.

For example, a user may be planning a celebration of a bachelor party and seek advice about highly rated restaurants. Another user may be planning an important business meal and seek advice about highly rated restaurants. If restaurant recommendation systems provide only generalized ratings, it is possible that both users in this example could select the same restaurant, with mutually unfavorable results. More precision and specificity in selecting venues for specific occasions according to specified demographics would provide users with confidence in the similarity metric provided by the recommendation system and therefore be of great value to users.

Users of existing restaurant recommendation systems, therefore, would greatly benefit from:

an improvement in the precision and specificity of particular components of the recommendation, so that pricing expectations are properly understood by the user.

an improvement in the precision and specificity of particular components of the recommendation, so that attire expectations are clearly understood by the user.

an improvement in the consistency and presentation of the rating methodology of the recommendation system so that users can make better value judgments, based upon their specific occasion and demographic preferences.

3. Objects and Advantages

Accordingly, several objects and advantages of this invention are:

(a) to provide a system and associated method which provides an enhancement to a restaurant recommendation system wherein a user is presented with precise information on the price expectations for a particular dining establishment, so the user can make an appropriate venue selection;

(b) to provide a system and associated method which provides an enhancement to a restaurant recommendation system wherein a user is presented with precise information on what is considered to be proper attire for a particular dining establishment, so the user can make an appropriate venue selection;

(c) to provide a system and associated method which provides an enhancement to a restaurant recommendation system wherein a user is presented with precise information on the rating and ranking of various dining establishments within the context of planning for a given special occasion and demographic specific event, so the user can make an appropriate venue selection;

(d) to provide a system and associated method which provides an enhancement to a restaurant recommendation system wherein a user is presented with the information about all of these objects in a single location, so a user requires less time for their research.

Further objects and advantages of this invention will become apparent from a consideration of the drawings and ensuing description.

### SUMMARY

In accordance with the invention, a system and method for collecting, storing, and displaying specific information about restaurants, comprising an Internet-accessible database of pricing, a database of suggested attire, and a database of demographically determined establishment ratings.

### DRAWINGS—FIGURES

FIG. 1 is a table of restaurant recommendation systems and their Internet domain addresses.

FIG. 2 is a table of pricing information for a specific restaurant that is available on restaurant recommendation systems.

FIG. 3 is a table of suggested attire information for a specific restaurant that is available on restaurant recommendation systems.

FIG. 4 is a flowchart of the collection, storage, and dissemination of the information used in this invention.

FIGS. 5-7 are tables which show the formula for calculating pricing information.

FIG. 8 is a table which shows the method for indicating proper attire of this invention.

FIG. 9 is a table which shows the specific occasion and demographic categories of this invention.

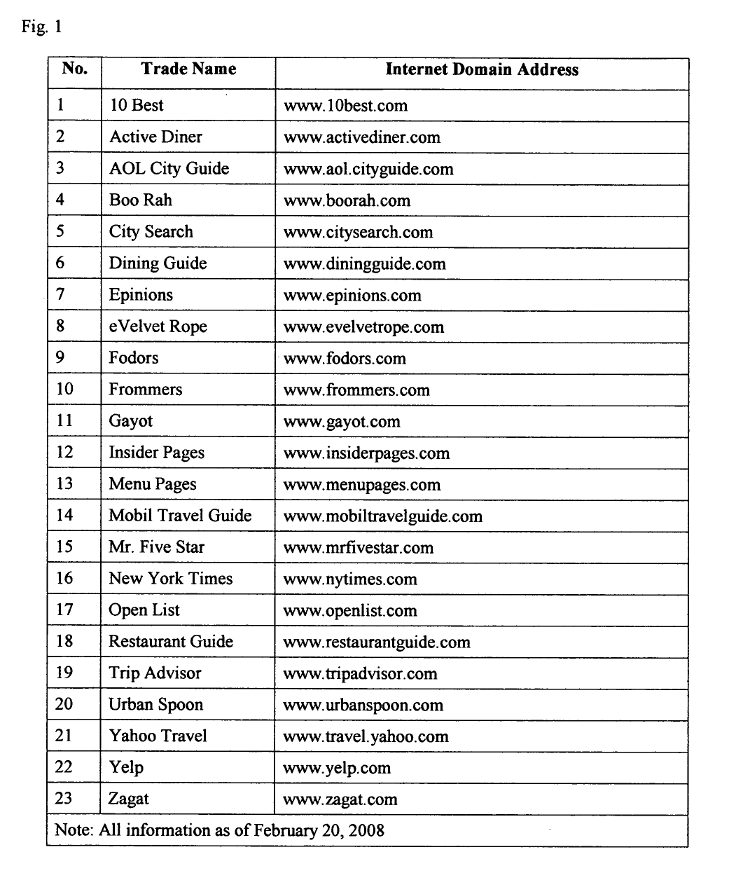

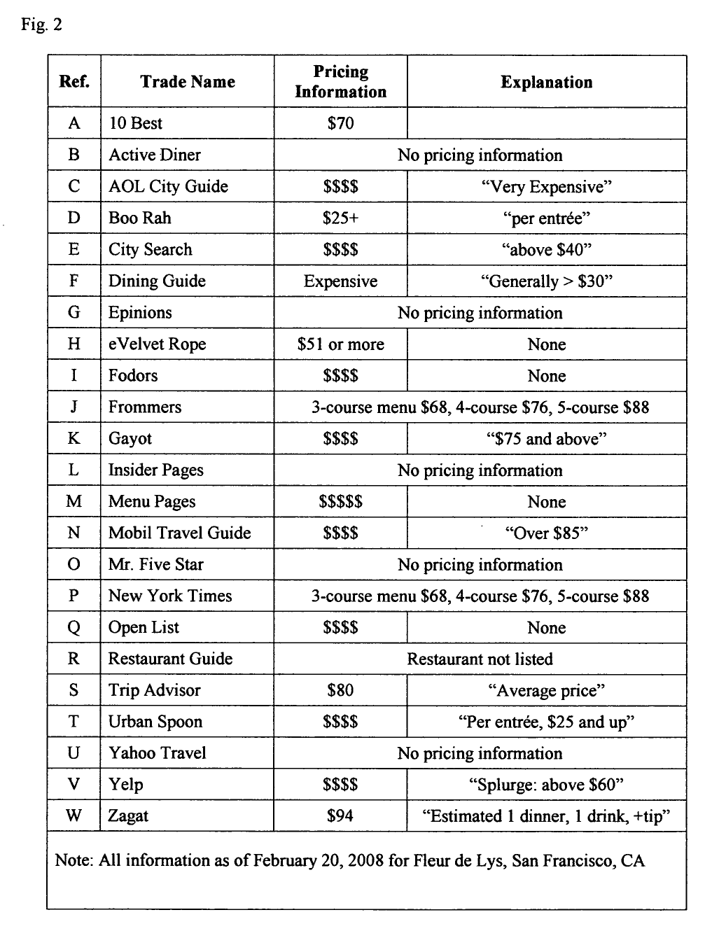

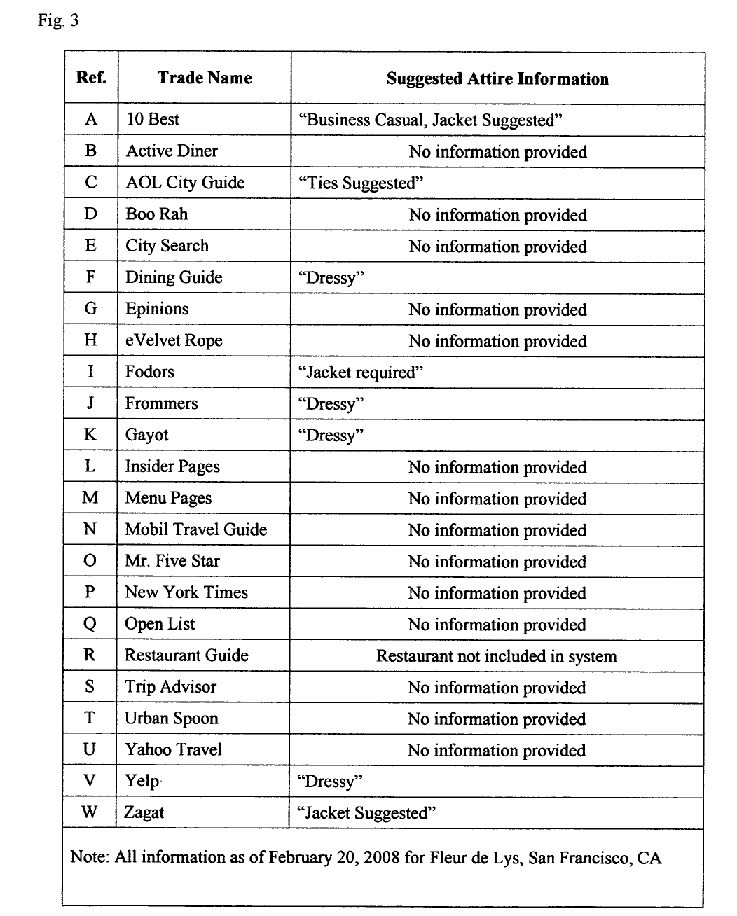

### DRAWINGS—REFERENCE NUMERALS

10 User

20 Internet

30 Server

40 System manager

50 Pricing database

60 Attire database

70 Ratings database

80 Demographics database

90 Administrator

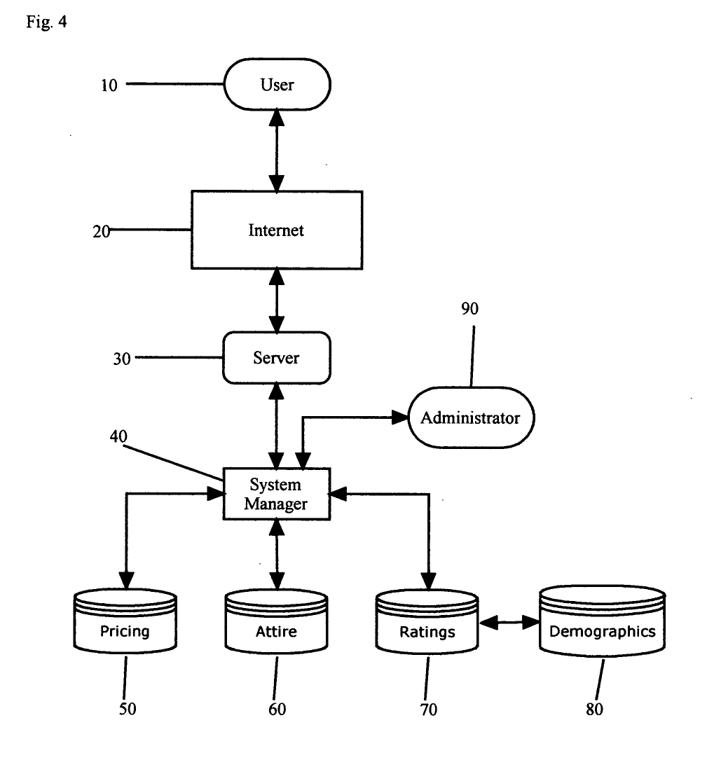

### DETAILED DESCRIPTION—PREFERRED EMBODIMENT—FIGS. 4-9

FIG. 4 shows a flowchart of the collection, storage, and dissemination of the information used in this invention. Via the Internet 20, user 10 accesses server 30 upon which resides the system manager 40. System manager 40 contains a database of pricing information 50, a database of attire information 60, a database of ratings information 70, and a database of user demographics 80. System manager 40 also contains software necessary to accept, process, store, and display data to user 10.

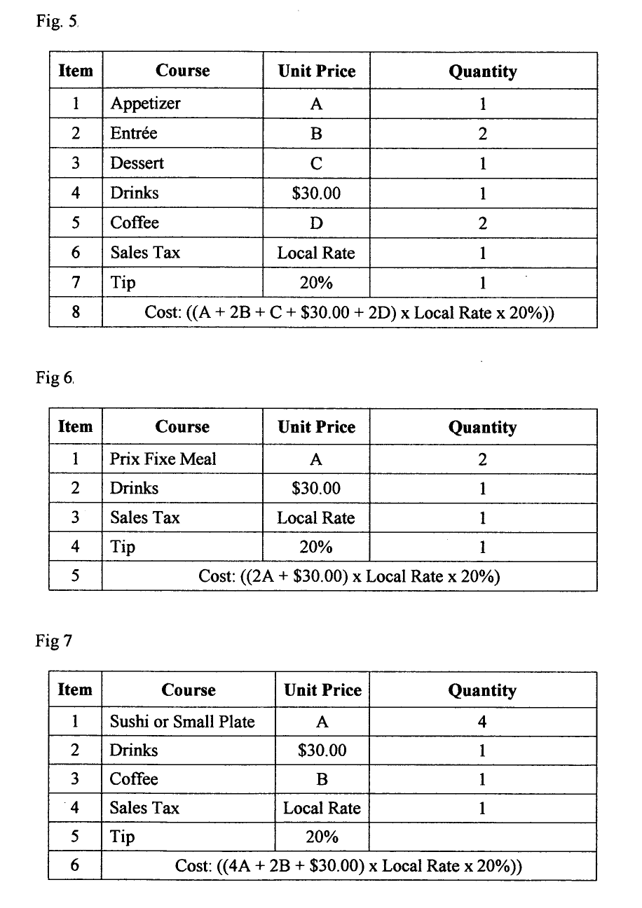

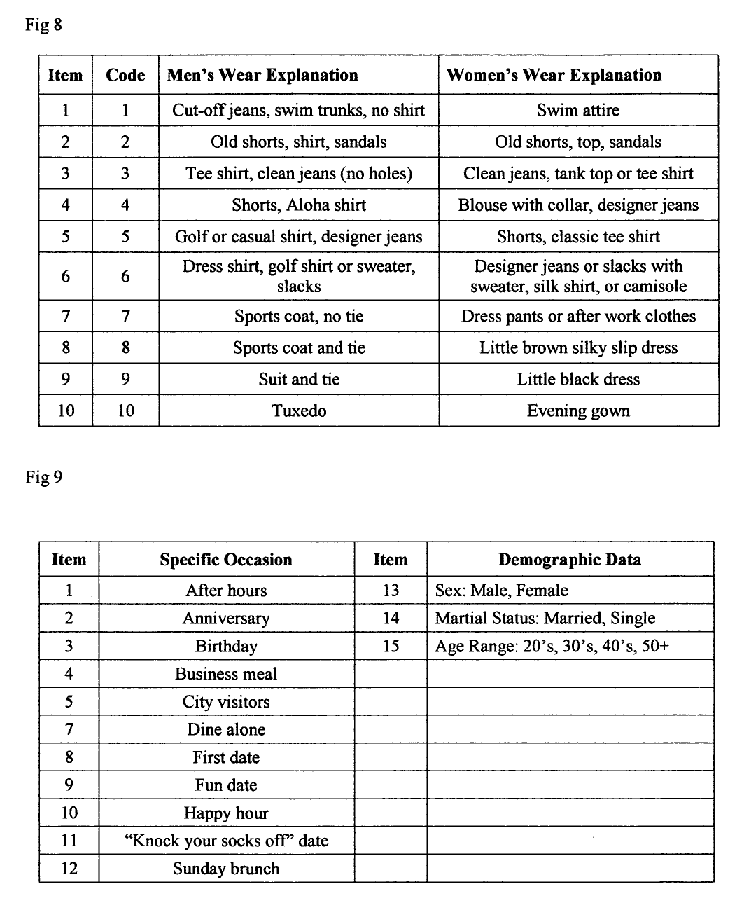

To request information about a particular dining establishment, user 10 accesses server 30. Server 30 displays pricing information for the specified restaurant according to the formulae detailed in FIGS. 5-7. Server 30 displays attire information for the specified restaurant according to the codes detailed in FIG. 8. Server 30 displays rating information for the specified restaurant according to the formula detailed in FIG. 9.

User 10 may access server 30 to provide information about a dining establishment that is not included in the server 30 database. Upon request, server 30 displays a form so that user 10 is able to enter data into the pricing, attire, and rating databases. Administrator 90 reviews data from user 10 and performs appropriate edits.

System manager 40 performs functions appropriate for maintaining centralized databases, including the creation and distribution of a selection of forms which enable users to interact with the database. These forms also provide users with the ability to rate dining establishments, and, more importantly, to establish a relative popularity ranking of a given establishment based on various filters. Users may, for example, use forms to provide input on specific restaurants included in the database according to their opinion or experience of hosting or attending a specific type of special event at the cited restaurant.

### Operation—FIGS. 4-9

The manner of using the restaurant recommendation system is largely similar to using Internet-based restaurant recommendation systems in present use. Namely, as shown in FIG. 4, one or more users access the Internet and enter the appropriate domain address of the server 30.

Upon accessing the restaurant recommendation system, the first decision a user makes is the selection of a specific city. Unlike most other restaurant recommendation systems, the server contains information on only the most popular restaurants in a given city. Limiting the database to only those venues that are highly rated improves the similarity metric of the system.

Since the recommendation system contains information about restaurants in many cities, a user who is traveling out of town can expect to find a recommendation that is appropriate for their unique situation. If, for example, a user is planning a business trip, a restaurant can be selected that is situated in a convenient location and conducive to conducting business, as ranked by the demographic data specified by the user. The similarity metric of the recommendation system ensures that the ambiance of the venue is not overly loud, crowded, poorly lit, or other conditions which could interfere with the purpose of the meal.

The next factor a user specifies in this embodiment of a restaurant recommendation system is the type of specific occasion for which they are planning. Users of this system accept that the occasion often dictates what venue is appropriate. Users, for example, don't want to schedule a quiet anniversary dinner at a restaurant that is likely to be hosting a bachelor party at the same time.

The next factor a user considers in this embodiment of a restaurant recommendation system is the pricing. FIGS. 5-7 show the definition of a meal and the formula for establishing the price for different types of restaurants. A user planning a special occasion considers the true price as a critical part of their decision. In this embodiment of a restaurant recommendation system, the user does not have to rely on a pricing estimate or interpretation of symbols to know the anticipated cost because the formulae detailed in FIGS. 5-7 calculate the average cost to the nearest dollar. Because the database contains exact pricing information, the user's confidence in the similarity metric of this embodiment of a restaurant recommendation system is enhanced.

The next factor a user considers in this embodiment of a restaurant recommendation system is what to wear. FIG. 8 shows the method for communicating the proper attire for a given restaurant. A user planning a specific occasion considers the proper attire an important part of their decision, because they do not want to be dressed either too informally or too formally.

In the preferred embodiment, photographs of examples of appropriate attire for men and for women is displayed by the system. Current fashions that are appropriate for the venue and where they are available for purchase are also displayed.

A user choosing a venue for a specific occasion may select a restaurant based upon the attire they desire to wear. For example, a user can compare what they plan to wear with the examples shown by the system and determine if the restaurant will meet their needs for a particular occasion. Similarly, a user can assist their spouse in determining what to wear by examining the alternatives provided by this embodiment. Because the database contains specific information on proper attire, the user's confidence in the similarity metric of this embodiment of a restaurant recommendation system is enhanced.

The next factor a user considers in this embodiment of a restaurant recommendation system is the rating for the specified occasion. FIG. 9 shows a listing of both the types of specific occasions included in the database and the particulars of user demographic data. A user who is a married male in his 50's may have a different opinion of a suitable location for a business meal than the opinion of a single female in her 20's. Because the database contains detailed information on restaurant ratings for specific occasions according to associated demographic data, a user's confidence in the similarity metric of this embodiment of a restaurant recommendation system is greatly improved.

The preferred embodiment is expected to be a service that is free to all users. An additional embodiment, however, could take the form of a fee-based member organization, association, or dining club. In a fee-based access method, it is likely that the similarity metric would be perceived among members as quite high. New recommendation features could be developed to satisfy the particular needs of the paid membership groups, and an entirely new range of information services could be made available.

### Advantages

From the description above, a number of advantages become evident:

(a) the restaurant recommendation system presents users with precise information on the price expectations for a particular dining establishment, so the user can make an appropriate venue selection;

(b) the restaurant recommendation system presents users with precise information on what is considered to be proper attire for a particular dining establishment, so the user can make an appropriate venue selection;

(c) the restaurant recommendation system presents users with precise information on the rating and ranking of various dining establishments within the context of planning for a specific event, so the user can make an appropriate venue selection;

(d) the restaurant recommendation system presents users with precise information on the rating and ranking of various dining establishments based upon information obtained from through a high similarity metric, so the user can make an appropriate venue selection with increased confidence.

(e) the restaurant recommendation system presents users with information about all of these objects in a single location, so a user requires less time for their research.

### CONCLUSION, RAMIFICATIONS, AND SCOPE

Accordingly, the reader will see that the restaurant recommendation system of this invention provides users with the ability to improve their planning for a specific occasion. Selecting from only the venues endorsed by similar users, eliminating doubt and potential embarrassment about pricing, and providing specific information and examples of appropriate attire all combine to increase a user's confidence and ability to select a venue for a specific occasion.

While the above description contains many specificities, these should not be construed as limitations on the scope of the invention, but as exemplifications of the presently preferred embodiments thereof. Many other ramifications and variations are possible within the teachings of the invention.

We claim:

1. An Internet based method of providing a user a recommendation of a restaurant for a specific occasion, comprising:
(a) providing a user access to an Internet server comprising a system manager, a database of restaurant pricing, a database of appropriate restaurant attire, a database of restaurant ratings, and a database of user demographic information;
(b) said server and said system manager providing access to said user of said restaurant pricing database, said restaurant attire database, said restaurant ratings database, and said user demographic database;
(c) said server and said system manager displaying to said user exact pricing, examples of appropriate attire and where such attire is available for purchase, for a restaurant based upon a specific selection from said user demographic database so that said user plans properly for said specific occasion.
(d) said server and said system manager displaying to said user exact pricing, examples of appropriate attire and where such attire is available for purchase, for a restaurant based upon a specific selection from said user demographic database so that said user finds all information necessary to plan properly for said specific occasion in a single location and thereby saves time and effort.

2. An Internet based system of providing a user a recommendation of a restaurant for a specific occasion, comprising:
(a) providing a user access to an Internet server comprising a system manager, a database of restaurant pricing, a database of appropriate restaurant attire, a database of restaurant ratings, and a database of user demographic information;
(b) said server and said system manager providing access to said user of said restaurant pricing database, said restaurant attire database, said restaurant ratings database, and said user demographic database;
(c) said server and said system manager displaying to said user exact pricing, examples of appropriate attire and where such attire is available for purchase, for a restaurant based upon a specific selection from said user demographic database so that said user plans properly for said specific occasion.
(d) said server and said system manager displaying to said user exact pricing, examples of appropriate attire and where such attire is available for purchase, for a restaurant based upon a specific selection from said user demographic database so that said user finds all information necessary to plan properly for said specific occasion in a single location and thereby saves time and effort.
